(19) United States
(12) Patent Application Publication
(10) Pub. No.: US 2026/0202620 A1
(43) Pub. Date: Jul. 16, 2026

(54) INTEGRATED ADAPTER WITH INNER COVER

(71) Applicant: Huizhou Fibercan Industrial Co.,Ltd, Huizhou (CN)

(72) Inventor: Songsheng LI, Shenzhen (CN)

(21) Appl. No.: 19/562,409

(22) Filed: Mar. 10, 2026

(30) Foreign Application Priority Data
Jan. 28, 2026 (CN) 202620119918.6

(51) Int. Cl. G02B 6/38

(52) U.S. Cl. CPC G02B 6/3825; G02B 6/3849

(57) ABSTRACT

Provided is an integrated multi-link adapter with an inner cover, which has a frame sleeve structure, elastic inner cover devices are assembled and connected inside the frame sleeve structure, a metal clamp cover structure is assembled and connected on an outer side of the frame sleeve structure. There are two sets of elastic inner cover devices, each set of which includes an inner cover hinged inside the frame sleeve structure and a spring plate limited between the inner cover and the frame sleeve structure. When an external plug is inserted into second ports, the external plug touches the elastic inner cover devices. As the external plug enters the second ports, the external plug pushes the elastic inner cover devices into the insertion holes to achieve the purpose of entering the insertion holes. When the external plug exits, the elastic inner cover devices rebound to block the second ports.

### CROSS-REFERENCE TO RELATED APPLICATIONS

This application claims priority to Chinese Patent Application No. 202620119918.6, filed on January 28, 2026, which is hereby incorporated by reference in its entirety.

### TECHNICAL FIELD

The present disclosure relates to the field of communication technology technologies, and in particular, to an integrated MPO multi-link adapter.

### BACKGROUND

With the increasing demand for communication bandwidth, optical fibers have been widely used in wired communication networks, Multi-fiber Push On, (MPO) adapter is a type of fiber optic adapter used for high-speed signal transmission and widely used in integrated cabling and data centers. Currently, the commonly used MPO plug adapters on the market can be used to plug in plugs at two ends. In the existing technology, MPO adapters are installed by docking with ordinary adapters, and the MT cores of the adapters are exposed for docking. At the same time, the adapters and adapters can only protect large dust particles in millimeters from entering the equipment. For communication equipment, dust can cause corrosion and damage inside the adapters and equipment, directly affecting the subsequent use effect of MPO adapters and network communication effect. There are also some MPO adapters with independent dust covers for port optimization, but due to the frequent insertion and extraction of ports, the dust covers are prone to getting lost during this process, and it is also easy to forget to re-cover the dust covers into the ports after unplugging the mating plugs. Especially for multi-link MPO adapters, due to the large number of links, the overall length of the adapter is too long, and the available space between each link is limited. The space for using internal dust covers is not large. The present disclosure aims to solve this problem and make the entire MPO adapter easy, fast, and cost-effective to assemble.

In order to overcome the shortcomings of existing technology, the present disclosure provides an integrated multi-link adapter with an inner cover.

The technical solution adopted by the present disclosure to solve its technical problem is: an integrated adapter with an inner cover, including: a frame sleeve structure, where elastic inner cover devices are assembled and connected to the frame sleeve structure, and a metal clamp cover structure is assembled and connected to an outer side of the frame sleeve structure, the outer frame body is provided with a plurality of first ports and second ports arranged in a linear manner, the second ports of the frame sleeve structure are assembled and connected to two sets of elastic inner cover devices, each set of elastic inner cover devices include an inner cover hinged in the frame sleeve structure and a spring plate limited between the inner cover and the frame sleeve structure.

In some embodiments of the present disclosure, the frame sleeve structure includes an outer frame body and an inner frame body assembled inside the outer frame body; the outer frame body is provided with a plurality of linearly arranged insertion holes, each of the insertion holes is assembled and connected to the inner frame body; the outer frame body is provided with an outer flange at a middle position of an outer side, and the outer flange is provided with a buckle hole; the outer frame body is connected to a second half body along a first half body divided along a centerline of the outer flange, and the insertion holes penetrate through the first half body and the second half body, each of the insertion holes in the second half body is provided with an inner frame body, the first ports are provided on one side of the first half body, and the second ports are provided on one side of the second half body, the inner frame body is inserted into the second half body from the second ports, the inner frame body is fastened to the outer flange, the inner cover is hinged to the inner frame body, and the spring plate is limited between the inner cover and the inner frame body.

In some embodiments of the present disclosure, the inner frame body includes a first narrow side wall, a second narrow side wall, a third long side wall, and a fourth long side wall enclosing a square body, where the third long side wall and the fourth side wall are both provided with a second installation hole that communicates with the insertion holes, and the third long side wall and the fourth long side wall are both provided with installation steps that communicate with the second installation hole, the installation steps are provided with positioning holes that communicate with the insertion holes; the third long side wall or the third long side wall is provided with a mounting hinge half circle on one side of the second installation hole, and the mounting hinge half circle is provided on a lower side of the installation step, a lower part of the installation step is provided with a first gear, and a connection between the first narrow side wall and the third long side wall is provided with a connection gear; a bottom of the connection gear is fixedly connected to the fist gear.

In some embodiments of the present disclosure, both the first narrow side wall and the second narrow side wall are both provided with a first installation groove and a second installation groove, where the first installation groove is provided with a clamp strip facing the positioning hole, the second installation groove is provided with a buckle arm, the buckle arm is provided with a buckle, the buckle is connected to the buckle hole of the outer flange, and there is a first gap between the clamp strip and the first installation groove; there is a second gap between the buckle arm and the second installation groove.

In some embodiments of the present disclosure, the inner cover includes a cover body and a hinge rod fixedly connected to the cover body.

In some embodiments of the present disclosure, the spring plate includes a spring pressing body, a spring plate positioning portion is fixedly connected to the spring pressing body, the spring pressing body is an arc shape, the spring pressing body forms a certain angle with the spring plate positioning portion, the spring plate positioning portion includes a flat plate surface, the spring pressing body is fixedly connected to one side of the flat plate surface, and the spring plate positioning portion further includes a positioning bracket vertically fixedly connected to an other side of the flat plate surface.

The beneficial effect of the present disclosure is to provide MPO pre-assembled adapters. During assembly, the inner cover is first installed into the inner frame body, and the hinge rod is hinged to the mounting hinge half circle. After the inner cover is installed, the spring plate is installed, and the inner cover and spring plate are installed together with the inner frame body into the insertion holes. The spring plate is limited between the inner frame sleeve and the outer frame sleeve, completing the installation of a link, which is easy to assemble and operate. It also overcomes the problem of limited space between each link due to the excessive number of links in the frame sleeve structure, which makes it impossible to install dust covers. The overall structure is compact, and the installation of the elastic inner cover devices achieves the purpose of dust prevention. The overall assembly is simple. When the external plug is inserted into the second ports, the external plug enters the insertion holes and pushes the cover body to open. The cover body opens around the hinge rod, thereby providing space for the external plug to be inserted. When the external plug is withdrawn, the external pushing force on the plug is lost. Under the action of the spring pressing body on the cover body, the cover body rotates around the hinge rod towards the second ports for reset. During the reset process of the cover body, the top side of the cover body is blocked by the first gear, thereby determining the reset position of the cover body. This ensures that the two symmetrical inner covers can completely block the second ports for dust prevention during reset, and avoid excessive reset of the two symmetrical inner covers, which may affect the dust prevention function of the cover body on the second ports. In a limited space, the multi-link MPO adapters can be realized by connecting the external plug with the present disclosure. When there is no need to connect, a dustproof plate can be closed, rendering the operation convenient and simple, reducing dust from entering the dustproof shell, and achieving good dustproof effect.

### BRIEF DESCRIPTION OF DRAWINGS

FIG. 1 is a schematic structural diagram of an integrated multi-link adapter with an inner cover of the present disclosure.

FIG. 2 is a schematic diagram of an exploded structure of the integrated multi-link adapter with an inner cover according to the present disclosure.

FIG. 3 is a schematic structural diagram of a frame sleeve of the integrated multi-link adapter with an inner cover of the present disclosure.

FIG. 4 is a schematic structural diagram of an inner cover of the integrated multi-link adapter with an inner cover according to the present disclosure.

FIG. 5 is a schematic structural diagram of a spring plate of the integrated multi-link adapter with an inner cover of the present disclosure

FIG. 6 is a schematic structural diagram of an inner frame sleeve of the integrated multi-link adapter with an inner cover of the present disclosure.

### DESCRIPTION OF EMBODIMENTS

The embodiments of the present disclosure will be described below in combination with the accompanying drawings and relevant embodiments. The embodiments of the present disclosure are not limited to the following embodiments, and the present disclosure relates to necessary components in this technical field, which should be regarded as well-known technology in this technical field and can be known and mastered by those skilled in the art.

In the description of the present disclosure, it should be noted that terms “up”, “down”, “inside”, “outside”, etc. indicate orientation or positional relationships based on the orientation or positional relationships shown in the accompanying drawings, or the orientation or positional relationships commonly used when using the product of the present disclosure. This is only for the convenience of describing the present disclosure and simplifying the description, and does not indicate or imply that the device or component referred to must have a specific orientation, be constructed and operated in a specific orientation, and therefore cannot be understood as a limitation of the present disclosure. Besides that, terms “one”, “two”, etc. are only used to distinguish descriptions and cannot be understood as indicating or implying relative importance. In the description of the present disclosure, it should be noted that unless otherwise specified and limited, terms “providing” and “connection” should be broadly understood, for example, it can be a fixed connection, a detachable connection, or an integrated connection; it can be a mechanical connection or an electrical connection; it can be directly connected, indirectly connected through an intermediate medium, or connected internally between two components. For those skilled in the art, specific meanings of the above terms in the present disclosure can be understood in specific situations.

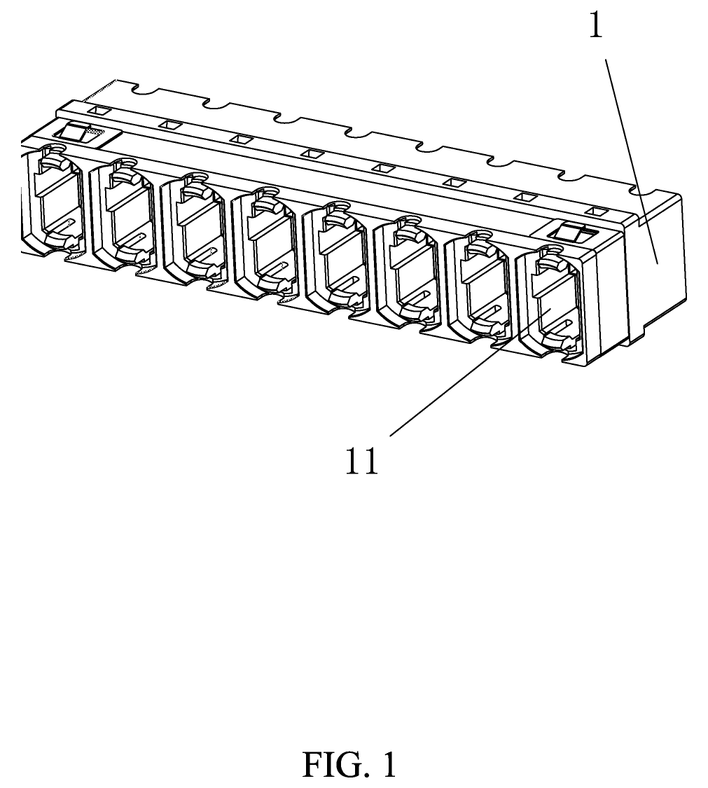

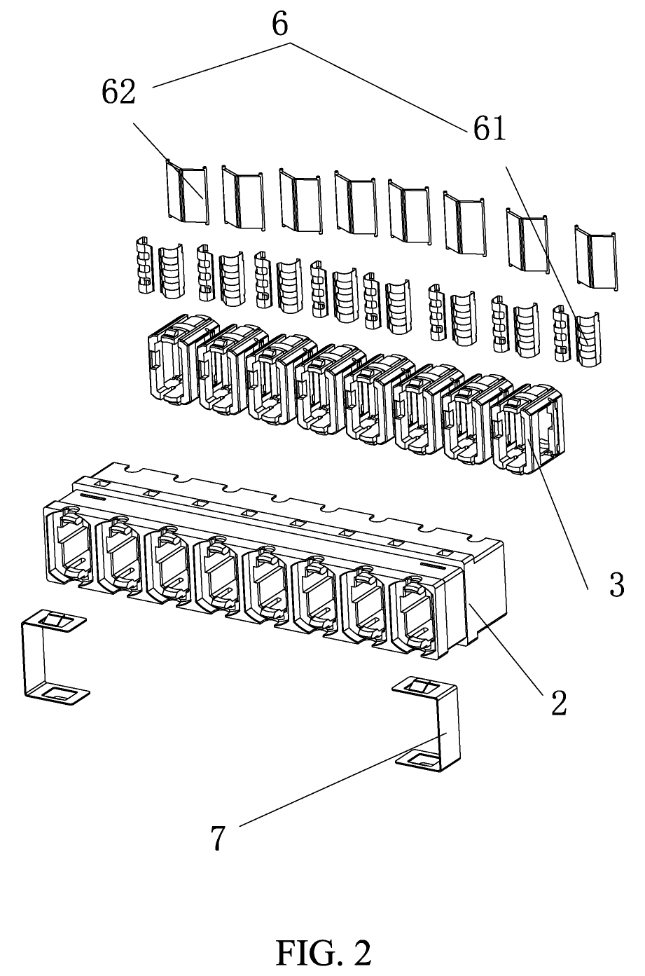

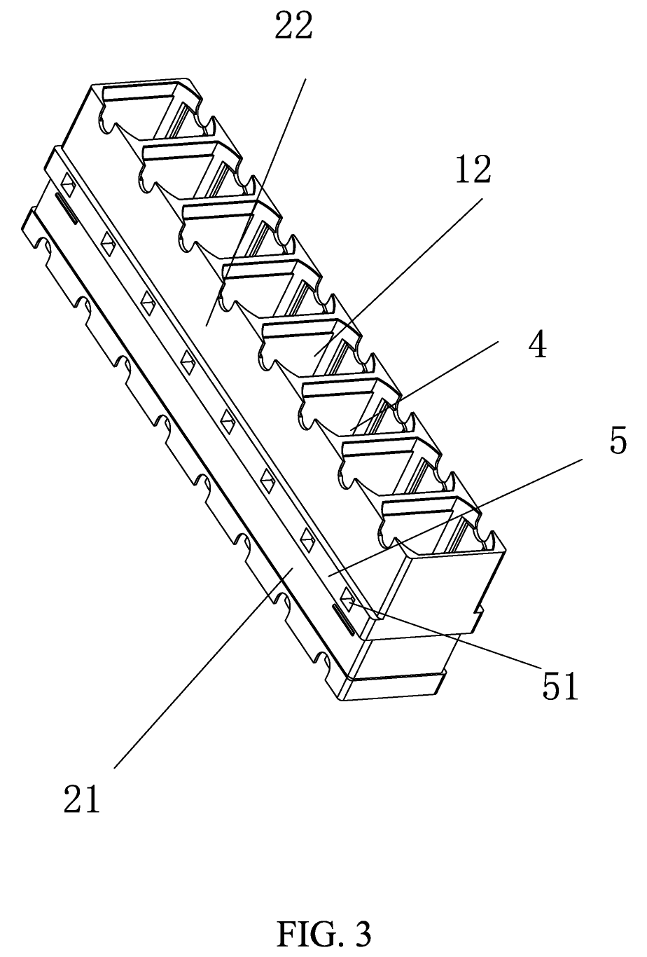

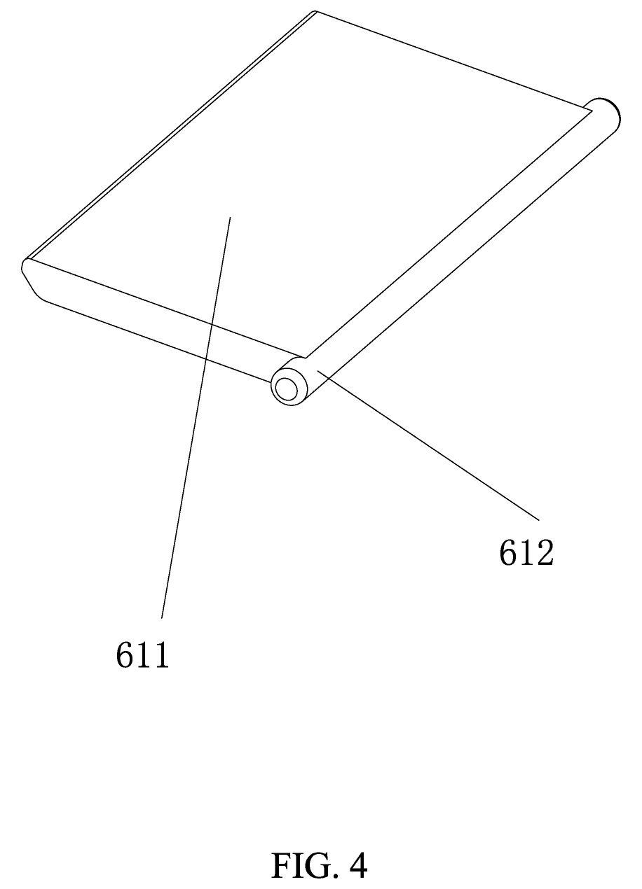

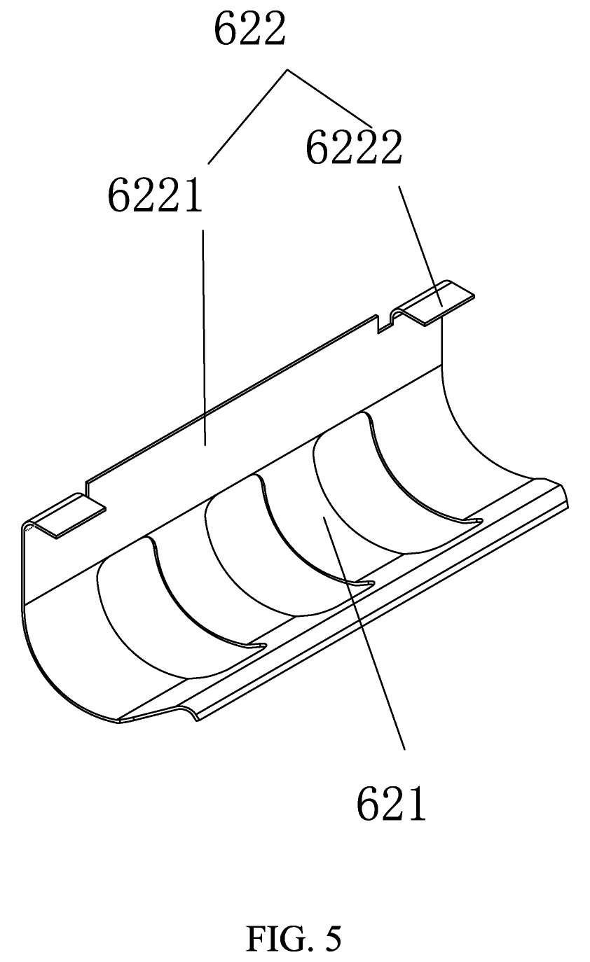

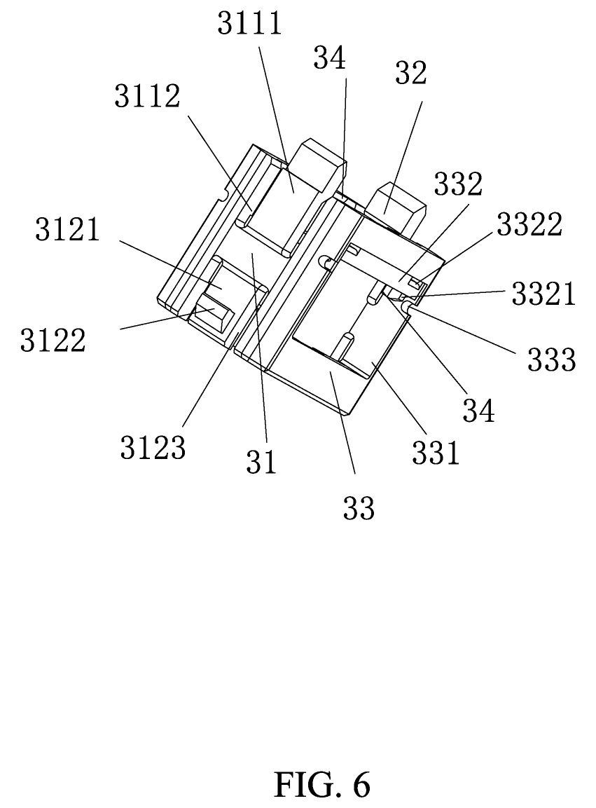

Referring to FIGS. 1 to 6, the present disclosure is implemented as follows: an integrated multi-link adapter with an inner cover, including a frame sleeve structure 1, elastic inner cover devices 6 are assembled and connected inside the frame sleeve structure 1, a metal clamp cover structure 7 is assembled and connected on an outer side of the frame sleeve structure 1, the outer frame body 2 is provided with a linear arrangement of a plurality of first ports 11 and second ports 12, the second ports 12 of the frame sleeve structure 1 are assembled and connected with the elastic inner cover devices 6, and the first metal cover 7 is assembled and connected on an outer side of the frame sleeve structure 1. There are two sets of elastic inner cover devices 6, each set of which includes an inner cover 61 hinged inside the frame sleeve structure 1 and a spring plate 62 limited between the inner cover 61 and the frame sleeve structure 1.

When the present disclosure is put into practice, both the first ports 11 and the second ports 12 can be plugged with an external plug. The frequency of plugging with the first ports 11 is relatively low, while the frequency of plugging with the second ports 12 is relatively high. When the external plug is plugged with the second ports 12, the external plug contacts the elastic inner cover devices 6. As the external plug enters the second ports 12, the external plug pushes the elastic inner cover devices 6 forward to enter the insertion holes 4. When the external plug exits, the elastic inner cover device 6 rebounds to block the second ports 12, thereby playing a dust-proof role and ensuring good signal transmission quality during connection. The present disclosure overcomes the limitation of the available space between each link due to the excessive number of links in the frame sleeve structure 1, and the elastic inner cover devices 6 is installed to achieve the purpose of dust prevention. When the external plug is plugged in with the present disclosure, a dustproof plate can be closed when there is no need for docking. The operation is convenient, simple, and cost-effective, reducing the entry of dust into a dustproof shell and achieving good dustproof effect.

The present disclosure is practical for inserting external equipment into a cabinet machine. The present disclosure has the first metal cover 7, and one end of the first metal cover 7 is inserted into a gap at a connection point of the cabinet. The first metal cover 7 is deformed under force, and after being inserted into the gap of the cabinet, it immediately returns to its original state, rendering the present disclosure unable to fall back off.

In an implementation mode, the frame sleeve structure 1 includes an outer frame body 2 and an inner frame body 3 assembled inside the outer frame body 2. The outer frame body 2 is provided with a plurality of linearly arranged insertion holes 4, each of which is assembled and connected to the inner frame body 3. The elastic inner cover devices 6 are provided inside the inner frame body 3, and an outer flange 5 is provided at a middle position of the outer side of the outer frame body 2. The outer flange 5 is provided with a buckle hole 51, and the inner frame body 3 is buckled to the buckle hole 51. The outer frame body 2 is composed of a first half body 21 and a second half body 22 divided along a centerline of the outer flange 5, and the insertion holes 4 penetrate through the first half body 21 and the second half body 22, each of the insertion holes 4 in the second half body 22 is provided with an inner frame body 3, the first ports 11 are provided on one side of the first half body 21, and the second ports 12 are provided on one side of the second half body 22. The inner frame body 3 is inserted into the second half body 22 from the second ports 12, and is fastened to the outer flange 5. The inner cover 61 is hinged to the inner frame 3, and the spring plate 62 is limited between the inner cover 61 and the inner frame body 3.

The setting of the inner frame body 3, and the inner frame body 3 being fastened to the buckle hole 51 of the outer flange 5 provide installation positioning space for the elastic inner cover devices 6. The inner frame body 3 is fastened to the outer flange 5, saving assembly space. The setting of the outer flange 5 can ensure the accurate and stable position of the present disclosure when clamped with external cabinets.

In an implementation mode, the inner frame body 3 includes a first narrow side wall 31, a second narrow side wall 32, a third long side wall 33, and a fourth long side wall 34 surrounding a square body. The third long side wall 33 and the fourth side wall are both provided with a second installation hole 331 that communicates with the insertion holes 4. The third long side wall 33 and the fourth long side wall 34 are both provided with an installation step 332 that communicates with the second installation hole 331. The installation step 332 is provided with a positioning hole 3322 that communicates with the insertion holes 4. The third long side wall 33 or the third long side wall 33 is provided with an installation hinge half circle 333 on one side of the second installation hole 331. The installation hinge half circle 333 is provided on a lower side of the installation step 332. A lower part of the installation step 332 is provided with a first gear 3321. A connection between the first narrow side wall 31 and the third long side wall 33 is provided with a connection gear 34, a bottom of the connection gear 34 is fixedly connected to the first gear 3321.

The first narrow side wall 31 and the second narrow side wall 32 are both provided with a first installation groove 311 and a second installation groove 312. The first installation groove 311 is provided with a clamp strip 3111 facing the positioning hole 3322, and the second installation groove 312 is provided with a buckle arm 3121. The buckle arm 3121 is provided with a buckle 3122, and the buckle 3122 is connected to the buckle hole 51 of the outer flange 5. There is a fist gap 3112 between the clamp strip 3111 and the first installation groove 311, and a second gap 3123 between the buckle arm 3121 and the second installation groove 312.

The setting of the clamp strip 3111 can ensure that the external plug can clamp the external plug after being plugged into the second ports 12, rendering the plugging more stable and ensuring the stability of overall signal transmission. When the inner frame body 3 is installed into the insertion hole, the buckle 3122 of the inner frame body 3 is connected to the buckle hole 51 of the outer flange 5. There is the second gap 3123 between the buckle arm 3121 and the second installation groove 312, so that during the assembly of the inner frame body 3, the buckle arm 3121 has buffer space during a clamping process of the buckle 3122 and the buckle hole 51 that is for easy assembly and disassembly of the inner frame body 3 when needed.

The inner cover 61 includes a cover body 611 and a hinge rod 612 fixedly connected to the cover body 611.

The spring plate 62 includes a spring pressing body 621 and a spring plate positioning portion 622 fixedly connected to the spring pressing body 621. The spring pressing body 621 is arc-shaped, and the spring pressing body 621 forms a certain angle with the spring plate positioning portion 622. The spring plate positioning portion 622 includes a flat plate surface 6221, and the spring pressing body 621 is fixedly connected to one side of the flat plate surface 6221. The spring plate positioning portion 622 further includes a positioning bracket 6222 fixedly connected vertically to another side of the flat plate surface 6221.

When assembling, the inner cover 61 is first installed into the inner frame body 3. The hinge rod 612 is connected to the installation hinge half circle 333. After installing the inner cover 61, the spring plate 62 is installed. The spring plate positioning portion 622 covers the outer side of the installation step 332 and exposes the hinger rod on the outer side of the installation hinge half circle 333. The positioning bracket 6222 of the spring plate 62 penetrates into the positioning hole 3322 to ensure that the entire spring plate 62 can be temporarily positioned after installation. After installing the inner cover 61 and the spring plate 62, the inner cover 61 and the spring plate 62 are installed together with the inner frame body 3 into the insertion holes 4. The buckle 3122 of the inner frame body 3 is engaged with the buckle hole 51 of the outer flange 5, when the inner frame body 3 enters the insertion holes 4, the spring plate 62 is limited between the inner frame sleeve and the outer frame sleeve, thereby completing the installation of a link.

After assembly, the main body of the spring plate 62 is in elastic contact with the cover body 611 of the inner cover 61. The inner cover 61 blocks the second ports 12 under the elastic force of a main body of the spring plate 62. A position of the inner cover 61 blocking the second ports 12 is determined by the second gear 2 under an action of the elastic force. There are two symmetrical elastic inner cover devices 6, and there are two inner covers 61 to block the second ports 12, thereby achieving the purpose of dust prevention. After each link is installed, the first metal cover 7 is provided on an outside of the outer frame sleeve, completing the assembly of the entire adapter. The assembly is simple and overcomes the problem of limited space between each link due to the large number of links in the frame sleeve structure 1, rendering it impossible to install dust covers. The overall structure is compact, and the installation of the elastic inner cover devices 6 achieves the purpose of dust prevention. The overall assembly is simple.

When the external plug is inserted into the second ports 12, the external plug enters the insertion holes and pushes the cover body 611 to open. The cover body 611 opens around the hinge rod 612, and the main body of the spring plate 62 also rotates under a rotation of the cover body 611 and is limited between the cover body 611 and the inner frame body 3, thereby providing space for the external plug to be inserted.

When the external plug is withdrawn, the external pushing force on the plug is lost. Under the action of the elastic pressure of the spring pressing body 621 on the cover body 611, the cover body 611 rotates around the hinge rod 612 towards the second ports 12 to reset. During a reset process of the cover body 611, a top side of the cover body 611 is blocked by the first gear 3321, thereby determining the reset position of the cover body 611, ensuring that the two symmetrical inner covers 61 can completely block the second ports 12 for dust prevention during reset, and avoiding excessive reset of the two symmetrical inner covers 61, which may affect the dust prevention function of the cover body 611 on the second ports 12. The connection gear 34 renders the first gear 3321 more stable, ensuring a longer service life of the first gear 3321 when positioning the inner cover 61. In a limited space, the multi-link MPO adapters can be realized by connecting the external plug with the present disclosure. When there is no need to connect, a dustproof plate can be closed, rendering the operation convenient and simple, reducing dust from entering the dustproof shell, and achieving good dustproof effect.

The entire operation does not require manual operation and has good dust prevention effect. The entire assembly is also simple and easy to operate.

The preferred embodiments of the present disclosure should be noted that those skilled in the art may make a plurality of improvements and embellishments without departing from the principles of the present disclosure, and these improvements and embellishments should also be considered within the protection scope of the present disclosure.

What is claimed is:

1. An integrated adapter with an inner cover, comprising: a frame sleeve structure, wherein elastic inner cover devices are assembled and connected to the frame sleeve structure, and a metal clamp cover structure is assembled and connected to an outer side of the frame sleeve structure,
the outer frame body is provided with a plurality of first ports and second ports arranged in a linear manner,
the second ports of the frame sleeve structure are assembled and connected to two sets of elastic inner cover devices, each set of elastic inner cover devices comprise an inner cover hinged in the frame sleeve structure and a spring plate limited between the inner cover and the frame sleeve structure.

2. The integrated adapter with an inner cover according to claim 1, wherein the frame sleeve structure comprises an outer frame body and an inner frame body assembled inside the outer frame body;
the outer frame body is provided with a plurality of linearly arranged insertion holes, each of the insertion holes is assembled and connected to the inner frame body;
the outer frame body is provided with an outer flange at a middle position of an outer side, and the outer flange is provided with a buckle hole;
the outer frame body is connected to a second half body along a first half body divided along a centerline of the outer flange, and the insertion holes penetrate through the first half body and the second half body,
each of the insertion holes in the second half body is provided with an inner frame body, the first ports are provided on one side of the first half body, and the second ports are provided on one side of the second half body,
the inner frame body is inserted into the second half body from the second ports, the inner frame body is fastened to the outer flange, the inner cover is hinged to the inner frame body, and the spring plate is limited between the inner cover and the inner frame body.

3. The integrated adapter with an inner cover according to claim 1, wherein the inner frame body comprises a first narrow side wall, a second narrow side wall, a third long side wall, and a fourth long side wall enclosing a square body,
wherein the third long side wall and the fourth side wall are both provided with a second installation hole that communicates with the insertion holes, and the third long side wall and the fourth long side wall are both provided with installation steps that communicate with the second installation hole,
the installation steps are provided with positioning holes that communicate with the insertion holes;
the third long side wall or the third long side wall is provided with a mounting hinge half circle on one side of the second installation hole, and the mounting hinge half circle is provided on a lower side of the installation step, a lower part of the installation step is provided with a first gear, and a connection between the first narrow side wall and the third long side wall is provided with a connection gear;
a bottom of the connection gear is fixedly connected to the fist gear.

4. The integrated adapter with an inner cover according to claim 3, wherein both the first narrow side wall and the second narrow side wall are both provided with a first installation groove and a second installation groove,
wherein the first installation groove is provided with a clamp strip facing the positioning hole,
the second installation groove is provided with a buckle arm, the buckle arm is provided with a buckle,
the buckle is connected to the buckle hole of the outer flange, and there is a first gap between the clamp strip and the first installation groove;
there is a second gap between the buckle arm and the second installation groove.

5. The integrated adapter with an inner cover according to claim 1, wherein the inner cover comprises a cover body and a hinge rod fixedly connected to the cover body.

6. The integrated adapter with an inner cover according to claim 1, wherein the spring plate comprises a spring pressing body, a spring plate positioning portion is fixedly connected to the spring pressing body, the spring pressing body is an arc shape,
the spring pressing body forms a certain angle with the spring plate positioning portion, the spring plate positioning portion comprises a flat plate surface, the spring pressing body is fixedly connected to one side of the flat plate surface, and the spring plate positioning portion further comprises a positioning bracket vertically fixedly connected to an other side of the flat plate surface.
